(19) United States
(12) Patent Application Publication
(10) Pub. No.: US 2025/0260088 A1
(43) Pub. Date: Aug. 14, 2025

(54) ELECTRIC STORAGE APPARATUS

(71) Applicant: TOYOTA JIDOSHA KABUSHIKI KAISHA, Aichi-ken (JP)

(72) Inventors: Masataka OGUSHI, Nisshin-shi (JP); Taro MATSUSHITA, Toyokawa-shi (JP); Yukinari TANABE, Okazaki-shi (JP)

(73) Assignee: TOYOTA JIDOSHA KABUSHIKI KAISHA, Aichi-ken (JP)

(21) Appl. No.: 19/044,628

(22) Filed: Feb. 4, 2025

(30) Foreign Application Priority Data
Feb. 9, 2024 (JP) 2024-018930

(51) Int. Cl. H01M 10/6555; H01M 10/658; H01M 50/209; H01M 50/249; H01M 50/296

(52) U.S. Cl. CPC H01M 10/6555; H01M 10/658; H01M 50/209; H01M 50/249; H01M 50/296

(57) ABSTRACT

An electric storage apparatus according to the present disclosure includes: a plurality of stacked battery cells; a plurality of heat insulating plates provided between the plurality of battery cells; and a case for accommodating a cell stack including the plurality of battery cells and the plurality of heat insulating plates, in which each of the heat insulating plates is formed so as to cover an entire stack surface of the battery cell adjacent to the heat insulating plate and includes a tapered edge part so that it does not come into contact with an edge of the battery cell adjacent to the heat insulating plate.

### CROSS REFERENCE TO RELATED APPLICATIONS

This application is based upon and claims the benefit of priority from Japanese patent application No. 2024-018930, filed on Feb. 9, 2024, the disclosure of which is incorporated herein in its entirety by reference.

### BACKGROUND

The present disclosure relates to an electric storage apparatus.

Patent Literature 1 discloses a battery module including a plurality of battery cells arranged in a stacked manner and a plurality of buffer sheets arranged alternately with the plurality of battery cells.
Patent Literature 1: Japanese Unexamined Patent Application Publication No. 2023-046073

### SUMMARY

In the battery module disclosed in Patent Literature 1, when each of the buffer sheets is arranged so as to cover the entire stack surface of the battery cell adjacent to the buffer sheet in order to make it difficult for the plurality of battery cells to transmit heat to each other, there is a possibility that a load is applied from the buffer sheet to a peripheral part of the battery cell adjacent thereto, and as a result, the peripheral part of the battery cell is deteriorated. On the other hand, when each of the buffer sheets is arranged so as to cover a stack surface of the battery cell adjacent to the buffer sheet other than peripheral parts of the plurality of battery cells in order to suppress the deterioration of the peripheral parts, there is a possibility that heat of the plurality of battery cells is easily conducted to each other through the peripheral parts, and as a result, each battery cell deteriorates due to the heat. That is, the battery module disclosed in Patent Literature 1 has a problem that the deterioration of the peripheral parts of the plurality of battery cells due to heat cannot be suppressed while suppressing the deterioration of the plurality of battery cells due to a load.

The present disclosure is made in view of the above background, and it is an object of the present disclosure to provide an electric storage apparatus capable of suppressing the deterioration of a plurality of battery cells due to heat while suppressing the deterioration of peripheral parts of the plurality of battery cells due to a load.

An electric storage apparatus according to the present disclosure includes: a plurality of stacked battery cells; a plurality of heat insulating plates provided between the plurality of battery cells; and a case for accommodating a cell stack including the plurality of battery cells and the plurality of heat insulating plates, in which each of the heat insulating plates is formed so as to cover an entire stack surface of the battery cell adjacent to the heat insulating plate and includes a tapered edge part so that it does not come into contact with an edge of the battery cell adjacent to the heat insulating plate. In the electric storage apparatus, each of the heat insulating plates is formed so as to cover an entire stack surface of the battery cell adjacent to the heat insulating plate. This makes it difficult for the plurality of battery cells to conduct heat to each other, so that deterioration of each battery cell due to heat is suppressed. Further, in the electric storage apparatus, each of the heat insulating plates includes a tapered edge part so that it does not come into contact with a peripheral part of the battery cell adjacent to the heat insulating plate. Thus, a load applied from each heat insulating plate to the peripheral part of the battery cell adjacent thereto is reduced, so that the deterioration of the peripheral part of each battery cell due to a load is suppressed. That is, the electric storage apparatus can suppress the deterioration of the plurality of battery cells due to heat while suppressing the deterioration of the peripheral parts of the plurality of battery cells due to a load.

According to the present disclosure, it is possible to provide an electric storage apparatus capable of suppressing the deterioration of a plurality of battery cells due to heat while suppressing the deterioration of peripheral parts of the plurality of battery cells due to a load.

The above and other objects, features and advantages of the present disclosure will become more fully understood from the detailed description given hereinbelow and the accompanying drawings.

### BRIEF DESCRIPTION OF DRAWINGS

FIG. 1 is a schematic perspective view showing an external view of a replaceable battery according to a first embodiment;

FIG. 2 is an enlarged schematic perspective view of the periphery of a front case provided at the front end of the replaceable battery according to the first embodiment;

FIG. 3 is an enlarged schematic perspective view of the periphery of a rear case provided at the rear end of the replaceable battery according to the first embodiment;

FIG. 4 is a flowchart showing the flow of assembly of the replaceable battery according to the first embodiment;

FIG. 5 is a schematic perspective view for explaining the flow of assembly of the replaceable battery according to the first embodiment;

FIG. 6 is a schematic perspective view for explaining the flow of assembly of the replaceable battery according to the first embodiment;

FIG. 7 is a schematic cross-sectional view of the ZX plane of the replaceable battery according to the first embodiment; and

FIG. 8 is a schematic exploded view of a cell stack installed in the replaceable battery according to the first embodiment.

### DESCRIPTION OF EMBODIMENTS

Hereinafter, the present disclosure will be described through embodiments of the present disclosure. However, the embodiments are not intended to limit the scope of the present disclosure according to the claims. Further, not all of the components/structures described in the embodiments are necessarily indispensable as means for solving the problem. Further, not all of the components/structures described in the embodiments are necessarily indispensable as means for solving the problem. In the figures, the identical reference symbols denote identical structural elements and redundant explanation thereof is omitted.

### First Embodiment

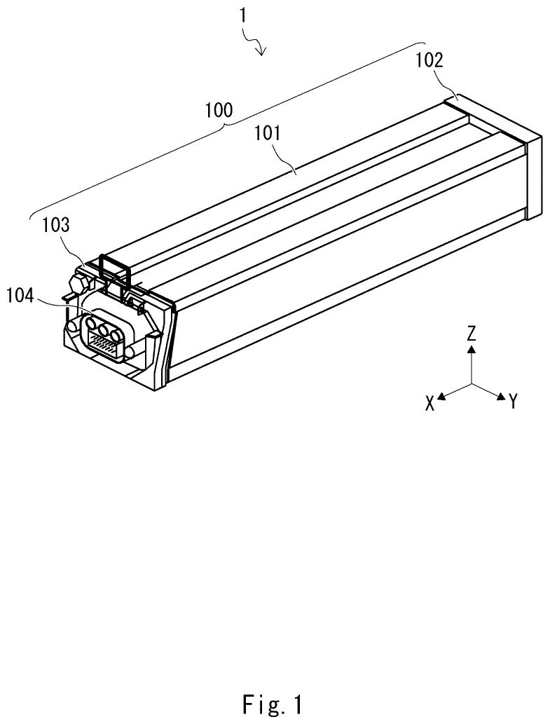

FIG. 1 is a schematic perspective view showing an external view of a replaceable battery 1 according to a first embodiment. The replaceable battery 1 is also referred to as a battery pack, a battery module, or the like, and is detachably attached to a vehicle such as an electric vehicle driven by a motor using electricity as a power source. The replaceable battery 1 is reduced in size and weight so that, for example, an operator can easily insert and remove the battery into and from the electric vehicle. Examples of an operator include a working robot.

As shown in FIG. 1, in the replaceable battery 1, the outside shape of a rectangular parallelepiped is defined by a case 100 for accommodating a cell stack or the like. The case 100 includes a case main body 101 having a rectangular tube shape, a front case 102 serving as a lid part for closing an opening part (namely, one opening end) at the front end of the case main body 101, and a rear case 103 serving as a lid part for closing an opening part (namely, the other opening end) at the rear end of the case main body 101. The rear case 103 provided at the rear end of the replaceable battery 1 includes a connector 104 protruding outward and formed to be connectable to a connector on the vehicle side. For example, when an operator accommodates the replaceable battery 1 in in housing space of the vehicle while sliding the replaceable battery 1 in the longitudinal direction (X-axis direction), the connector 104 of the replaceable battery 1 and the connector on the vehicle side are connected.

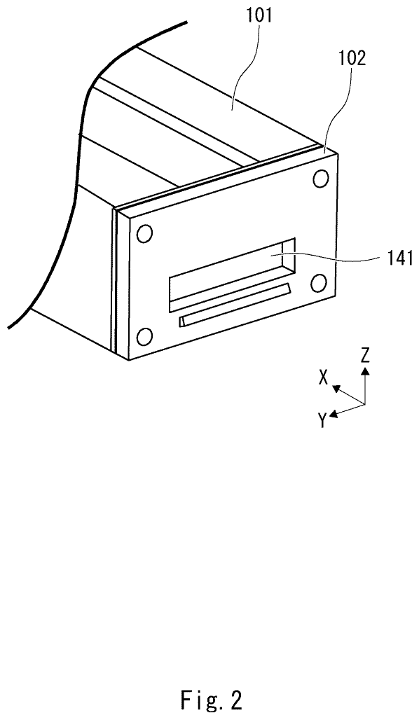

FIG. 2 is an enlarged schematic perspective view of the periphery of the front case 102 provided at the front end of the replaceable battery 1. As shown in FIG. 2, the front case 102 is provided with a pull-handle 141 for sliding the replaceable battery 1. An operator can slide the replaceable battery 1 by holding the pull-handle 141 and pushing or pulling the replaceable battery 1.

In addition, the replaceable battery 1 can be placed on, for example, a carriage and transported. When unloading the replaceable battery 1 from the carriage and housing it in the housing space, the height of the carriage is made to match with that of the housing space, and the replaceable battery 1 is housed in the housing space by pushing the pull-handle 141. On the other hand, when taking the replaceable battery 1 out of the housing space and loading it on the carriage, the height of the carriage is made to match that of the housing space, and the replaceable battery 1 is taken out of the housing space by pulling the pull-handle 141.

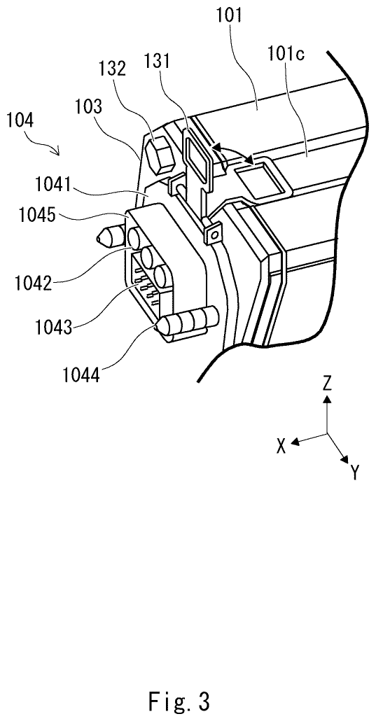

FIG. 3 is an enlarged schematic perspective view of the periphery of the rear case 103 provided at the rear end of the replaceable battery 1. As shown in FIG. 3, in addition to the connector 104, the rear case 103 is provided with a grip-handle 131 and a relief valve 132.

The connector 104 includes a base part 1041, a high-voltage terminal 1042, a low-voltage terminal 1043, an alignment pin 1044, and a metal cover 1045. The base part 1041 is disposed on the main surface of the rear case 103. The high-voltage terminal 1042, the low-voltage terminal 1043, and the alignment pin 1044 are each formed so at to project outwardly from the main surface of the base part 1041. The cover 1045 is formed to surround the side surfaces of the high-voltage terminal 1042 and the low-voltage terminal 1043. The high-voltage terminal 1042 is a terminal for transmitting electricity output from the cell stack housed in the case 100 of the replaceable battery 1 to a vehicle in which the replaceable battery 1 is mounted. The low-voltage terminal 1043 is a terminal for transmitting a control signal directed from the vehicle to the replaceable battery 1, and for transmitting a signal representing a monitoring result (a voltage measurement result, etc.) of the cell stack from the replaceable battery 1 to the vehicle.

The relief valve 132 discharges gas generated in the cell stack housed in the case 100 of the replaceable battery 1. Here, even when gas is discharged from the relief valve 132, the high-voltage terminal 1042 and the low-voltage terminal 1043 are protected by the metal cover 1045.

The grip-handle 131 is rotatably provided around an axis extending along the upper edge of the rear case 103, and is mounted on the upper surface of the case main body 101 when not in use. Therefore, the rear end of the replaceable battery 1 can be suspended by the grip-handle 131 without obstructing the connection of the connector 104.

More specifically, when an operator carries the replaceable battery 1, the operator holds the rotatable grip-handle 131 with one hand and lifts the replaceable battery 1 and at the same time holds the pull-handle 141 and supports the replaceable battery 1 with the other hand. By doing so, the operator can carry the replaceable battery 1 while stabilizing the center of gravity (i.e., maintaining balance).

Here, a rib groove 101c is formed on the upper surface of the case main body 101 along the longitudinal direction (X-axis direction) of the case main body 101. Therefore, the grip-handle 131 is accommodated in the rib groove 101c when not in use. This makes it easier for an operator to house the replaceable battery 1 in a housing space of the vehicle. Further, by forming the rib groove 101c, the strength of the upper surface of the case main body 101 is also improved.

The thickness of the case main body 101 is preferably made small, and the thickness of the rear case 103 is preferably larger than the thickness of the case main body 101. The case 100 is reduced in weight by reducing the thickness of the case main body 101, and the deformation of the case 100 is suppressed by providing the grip-handle 131 on the rear case 103 which is thicker. For example, a die-cast member is used as the rear case 103. With this configuration, the rigidity of the rear case 103 on which the grip-handle 131 is provided is improved, and the workability when the grip-handle 131 is used is also improved. Moreover, by reducing the thickness of the case main body 101, even when gas is generated in a cell stack 110, the case main body 101 is elastically deformed and inflates outward, so that a rapid increase in the internal pressure of the case is suppressed.

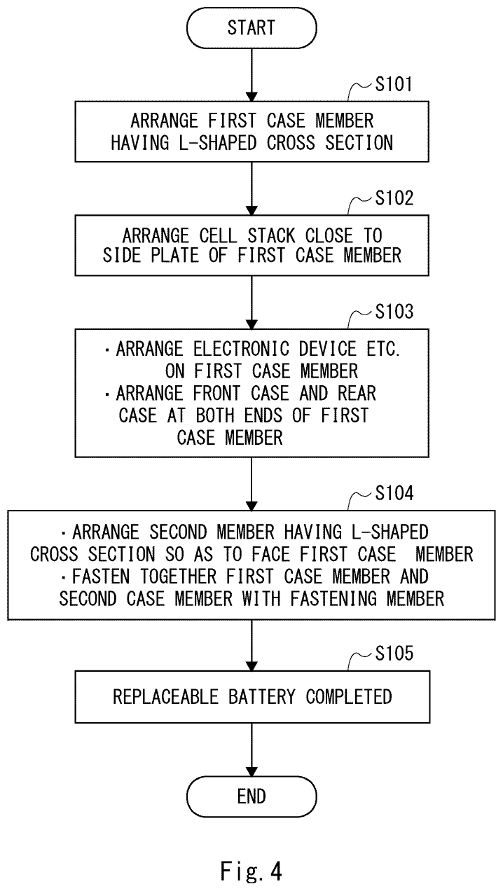

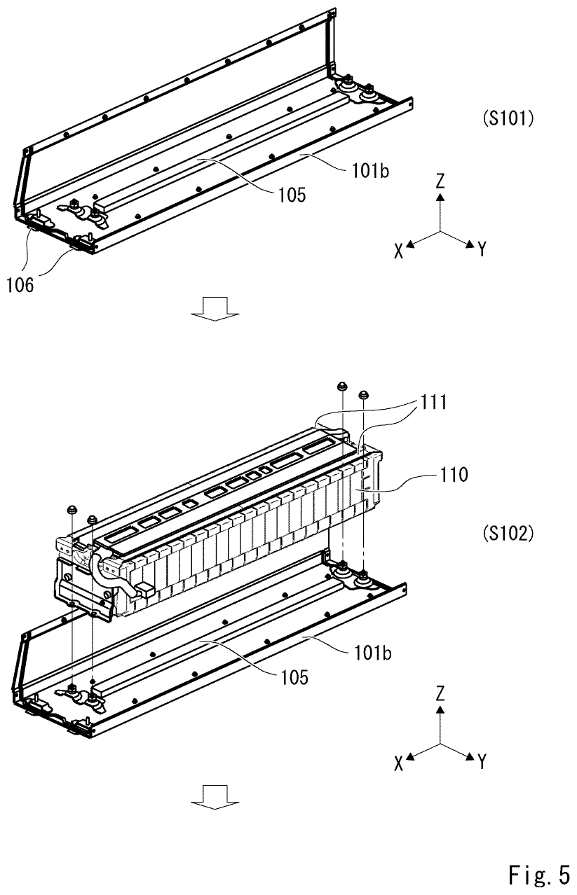

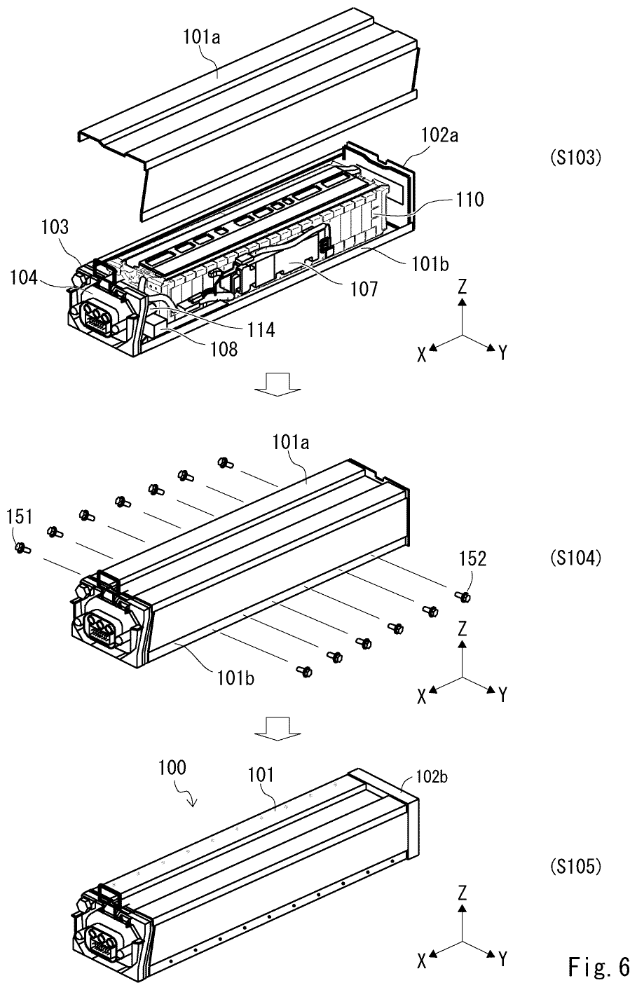

Next, the flow of assembly of the replaceable battery 1 will be described with reference to FIGS. 4 to 6, while the contents contained in the case 100 of the replaceable battery 1 are described. FIG. 4 is a flowchart showing the flow of assembly of the replaceable battery 1. FIGS. 5 and 6 are schematic perspective views for explaining the flow of assembly of the replaceable battery 1. The display contents of Steps S101 to S105 in FIGS. 5 and 6 correspond to the processing results of Steps S101 to S105 in FIG. 4.

First, a lower case 101b forming the bottom plate and one side plate of the case main body 101 is arranged (Step S101). The lower case 101b is formed so that its YZ section is L-shaped and extends along the X-axis direction. A pair of rails 106 are provided along the longitudinal direction (X-axis direction) of the lower case 101b on the lower side of the bottom plate formed by the lower case 101b. Thus, the replaceable battery 1 can easily slide along the guide. Further, a metal member 105 is provided along the longitudinal direction of the lower case 101b on the upper side of the bottom plate. The metal member 105 is formed of, for example, aluminum or an alloy containing aluminum (i.e., a metal mainly composed of aluminum).

Then, the cell stack 110 having a rectangular parallelepiped shape is arranged on the upper side of the bottom plate formed by the lower case 101b so as to be close to one side plate formed by the lower case 101b (Step S102). The cell stack 110 includes a plurality of stacked battery cells and a heat insulating plate provided between the plurality of battery cells. The cell stack 110 is bundled into a rectangular parallelepiped shape by a binding member 111 such as a binding band. Here, the metal member 105 provided on the upper side of the bottom plate formed by the lower case 101b and the lower side of the cell stack 110 serves to release heat of the cell stack 110 to the outside of the case 100.

Then, electronic devices such as a junction box 108 including a relay and a battery monitoring apparatus 107 are further arranged on the upper side of the bottom plate formed by the lower case 101b (Step S103). The battery monitoring apparatus 107 includes a voltage measuring device for measuring the voltage of the cell stack 110 and the voltage of each battery cell configuring the cell stack. The battery monitoring apparatus 107 is arranged in a spatial region between the cell stack 110 and the other side plate of the case main body 101 to be described later in the upper region of the bottom plate formed by the lower case 101b. This spatial region is formed by arranging the cell stack 110 close to one side plate of the case main body 101. The junction box 108 is arranged in a spatial region between the rear end of the cell stack 110 and the rear case 103 to be described later.

An inner-side case 102a of the front case 102 is arranged at the front end of the lower case 101b (the case main body 101) (Step S103). The rear case 103 including the connector 104 is arranged at the rear end of the lower case 101b (the case main body 101) (Step S103). The rear end of the cell stack 110 and the rear case 103 are connected via a support bar 114. As a result, a spatial area sufficient for arranging the junction box 108 is secured between the rear end of the cell stack 110 and the rear case 103. Further, the front end of the cell stack 110 and the front case 102 including the pull-handle 141 are connected, and the rear end of the cell stack 110 and the rear case 103 including the grip-handle 131 are connected via the support bar 114. As a result, when an operator holds the pull-handle 141 and the grip-handle 131 and lifts the replaceable battery 1, a load on the case main body 101 is reduced.

Thereafter, an upper case 101a forming a top plate and the other side plate of the case main body 101 are arranged so as to face the lower case 101b (Step S104). The upper case 101a is formed so that its YZ section is L-shaped and extends along the X-axis direction. The case main body 101 having a rectangular tube shape is formed of the upper case 101a and the lower case 101b. A spatial region 160 is provided above the cell stack 110 in the internal region of the case main body 101. The spatial region 160 is also used as a smoke exhaust region for releasing gas generated in the cell stack 110. For example, gas generated in the cell stack 110 is discharged from the spatial region 160 to the outside of the case 100 via the relief valve 132.

The upper case 101a and the lower case 101b are fastened together with fastening members 151 and 152 (Step S104).

Thereafter, an outer-side case 102b of the front case 102 is arranged at the front end of the case main body 101. Thus, the replaceable battery 1 is completed (Step S105). The case 102b has a cap shape and is attached so as to wrap the opening part (an opening end) at the front end of the case main body 101 from the side surface. Thus, before the gas is discharged from the relief valve 132, it is possible to suppress the gas from leaking out from the side of the front case 102 where an operator is working.

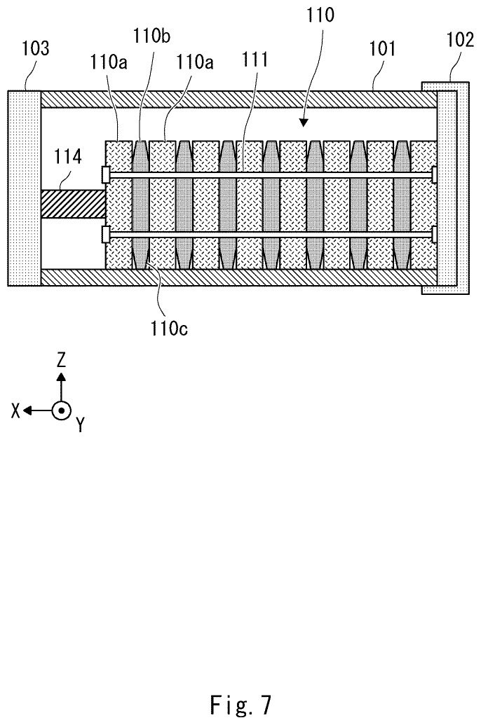

FIG. 7 is a schematic cross-sectional view of the ZX plane of the replaceable battery 1. As shown in FIG. 7, in the replaceable battery 1, the front end of the cell stack 110 and the front case 102 including the pull-handle 141 are connected, and the rear end of the cell stack 110 and the rear case 103 including the grip-handle 131 are connected via the support bar 114. Thus, when an operator holds the pull-handle 141 and the grip-handle 131 and lifts the replaceable battery 1, a load on the case main body 101 is reduced. As a result, the thickness of the case main body 101 of the replaceable battery 1 can be reduced, whereby it is possible to reduce the weight thereof.

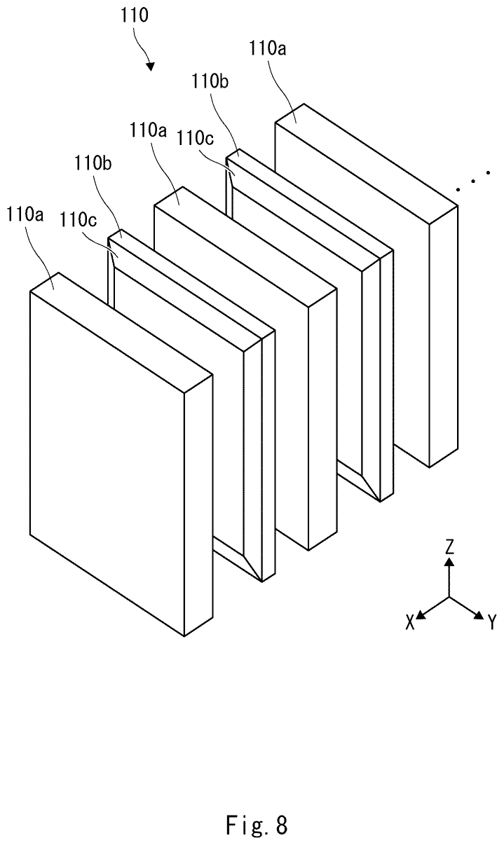

Further, as shown in FIG. 7, in the cell stack 110, a plurality of heat insulating plates 110b are provided between a plurality of stacked battery cells 110a. FIG. 8 is a schematic exploded view of the cell stack 110. Each battery cell 110a includes a rectangular stack surface, and each heat insulating plate 110b includes a rectangular stack surface. Each heat insulating plate 110b is composed of, for example, a heat insulating material formed by solidifying a heat insulating powder such as silica, and a film that wraps the heat insulating material. Here, each heat insulating plate 110b is formed so as to cover the entire stack surface of the battery cell 110a adjacent to the heat insulating plate. This makes it difficult for the plurality of battery cells 110a to conduct heat to each other, so that deterioration of each battery cell 110a due to heat is suppressed. Further, each heat insulating plate 110b includes a tapered edge part 110c so that it does not come into contact with a peripheral part (an edge) of the battery cell 110a adjacent to the heat insulating plate. Thus, a load applied from each heat insulating plate 110b to the peripheral part of the battery cell 110a adjacent thereto is reduced, so that the deterioration of the peripheral part of each battery cell 110a due to a load is suppressed.

Thus, in the replaceable battery 1 according to the present disclosure, each heat insulating plate 110b is formed so as to cover the entire stack surface of the battery cell 110a adjacent to the heat insulating plate. This makes it difficult for the plurality of battery cells 110a to conduct heat to each other, so that deterioration of each battery cell 110a due to heat is suppressed. Further, each heat insulating plate 110b includes the tapered edge part 110c so that it does not come into contact with a peripheral part (an edge) of the battery cell 110a adjacent to the heat insulating plate. Thus, a load applied from each heat insulating plate 110b to the peripheral part of the battery cell 110a adjacent thereto is reduced, so that the deterioration of the peripheral part of each battery cell 110a due to a load is suppressed. That is, the replaceable battery 1 according to the present disclosure can suppress the deterioration of the plurality of battery cells 110a due to heat while suppressing the deterioration of the peripheral parts of the plurality of battery cells 110a due to a load.

The present disclosure is not limited to the above-described embodiments and may be changed as appropriate without departing from the scope and spirit of the present disclosure.

In the present disclosure, a description has been given of a case in which in the cell stack mounted on the replaceable battery 1, each heat insulating plate is formed so as to cover the entire stack surface of the battery cell adjacent to the heat insulating plate and includes a tapered edge part so that it does not come into contact with the edge of the battery cell adjacent to the heat insulating plate. However, the present disclosure is not limited to this case. The cell stack according to the present disclosure may be applied to various electric storage apparatuses other than the replaceable battery.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An electric storage apparatus comprising:
a plurality of stacked battery cells;
a plurality of heat insulating plates provided between the plurality of battery cells; and
a case for accommodating a cell stack comprising the plurality of battery cells and the plurality of heat insulating plates,
wherein each of the heat insulating plates is formed so as to cover an entire stack surface of the battery cell adjacent to the heat insulating plate and includes a tapered edge part so that it does not come into contact with an edge of the battery cell adjacent to the heat insulating plate.

2. The electric storage apparatus according to claim 1, wherein each of the heat insulating plates comprises:
a heat insulating material formed by solidifying a heat insulating powder; and
a film that wraps the heat insulating material.

3. The electric storage apparatus according to claim 1, wherein the heat insulating plate contains silica.

4. The electric storage apparatus according to claim 1, wherein
the plurality of battery cells include rectangular stack surfaces, and
the plurality of heat insulating plates include rectangular stack surfaces.
